(19) United States
(12) Patent Application Publication
(10) Pub. No.: US 2015/0323128 A1
(43) Pub. Date: Nov. 12, 2015

(54) ITEM MOUNTING APPARATUS

(71) Applicant: Charles Edward William Garvey, Kitchener (CA)

(72) Inventor: Charles Edward William Garvey, Kitchener (CA)

(21) Appl. No.: 14/688,127

(22) Filed: Apr. 16, 2015

Related U.S. Application Data
(60) Provisional application No. 61/992,219, filed on May 12, 2014.

(51) Int. Cl. F16M 13/02; B65D 25/24; A47B 81/00

(52) U.S. Cl. CPC F16M 13/027; A47B 81/007; B65D 25/24

(57) ABSTRACT

The invention relates to item mounting apparatuses, and particularly, to apparatus that may be secured to a ceiling surface for mounting an item to the ceiling. The apparatus has an upper support securable to a ceiling surface having an outwardly depending alignment member, and a hub having an item support structure with a through aperture and a securing mechanism for releasable securing of the hub to the alignment member. The hub is secured to the alignment member, when the alignment member is inserted through the through aperture of the hub, through use of the securing mechanism. The securing mechanism may have a shaft collar with a spring loaded release mechanism. In one embodiment, the item support structure has a wheel support assembly having means for engaging a wheel and an outwardly extending hollow shaft, the hollow shaft configured for insertion in a centerbore of the wheel and for guiding the hub along the alignment member when mounting the wheel to the ceiling.

### CROSS-REFERENCE TO RELATED APPLICATIONS

This application claims the benefit of U.S. Provisional Patent Application Ser. No. 61/992,219 filed May 12, 2014, the entire contents of which is herein incorporated by reference.

### FIELD OF THE INVENTION

The invention relates to item mounting apparatuses, and particularly, to apparatus that may be secured to a ceiling surface for mounting an item to the ceiling.

### BACKGROUND

Arrangements for mounting items, for example wheels, on a wall or ceiling are known in the art. For example, nut and bolt arrangements for mounting wheels are known (e.g. GB 2258263, JP 56131467, U.S. Pat. No. 6,039,226) and other through-rim arrangements for securing wheels are known (e.g. DE 102011016516). Further, it is known to secure a hook to a ceiling-mounted bracket where the hook stem is male threaded for mating with a female threaded portion on the bracket (U.S. Pat. No. 7,165,685). It is also known to use threaded stems that extend through a wheel rim (e.g. JP 56131467, U.S. Pat. No. 6,039,226) that may help guide the wheel, but these stems are part of the securement structure and are not removable.

There remains a need for a simple, easily useable apparatus for mounting items to a ceiling.

### SUMMARY OF THE INVENTION

According to the present invention, there is provided an apparatus for mounting an item to a ceiling, comprising: an upper support securable to the ceiling having an outwardly depending alignment member; and, a hub comprising an item support structure and a through aperture through which the alignment member can extend and a hub securing mechanism for releasable securing of the hub to the alignment member when the alignment member extends through the through aperture of the hub.

In one embodiment, the item support structure comprises a wheel support assembly having a means for engaging a wheel, and having an outwardly extending hollow shaft. The outwardly extending hollow shaft may be configured for insertion in a centerbore of the wheel and for guiding the hub along the alignment member. The hollow shaft may comprise a hollow tube, the hollow tube being aligned with the through aperture of the hub and through which the alignment member extends when the alignment member extends through the through aperture of the hub.

The alignment member may extend through the hollow tube, the centerbore of the wheel and the through aperture of the hub when the wheel is supported on the wheel support assembly.

The means for engaging the wheel may comprise an annular flange, extending radially outward from the hub. The means for engaging the wheel may further comprise a pair of handles, extending radially outward from the hub, for supporting the wheel.

The hub securing mechanism may comprise a shaft collar. In one embodiment, the shaft collar may further comprise a spring loaded release mechanism having a U-shaped spring and a release element in contact with the U-shaped spring. The U-shaped spring may be biased into frictional engagement with the alignment member for securing the hub to the alignment member when a downward force is applied to the hub and may be released from biased frictional engagement upon compression of the release element. The through aperture of the hub may pass through the U-shaped spring of the spring loaded release mechanism.

The apparatus may further comprise an extender, which extender may be releasably connected to the alignment member for extending the alignment member. The extender may comprise a connection end, and the alignment member may comprise a connection end, wherein the connection end of the alignment member and the connection end of the extender form a spring-loaded bayonet connection. The spring-loaded bayonet connection allows for releasable securing of the extender to the alignment member.

In another embodiment, the item support structure may comprise a basket. The item support structure may further comprise one or more basket support brackets for supporting one or more baskets. The basket may comprise a square structure having a solid base and a solid side wall extending upward from the base. The item support structure may further comprise one or more basket support brackets, for supporting one or more baskets. The basket support bracket extends outward from the hub, and corresponds with an upper flange of the basket. The upper flange of the basket engages and is supported by the bracket. The bracket can be connected to the hub by any means known in the art, and one or more brackets may be connected to the hub, for supporting one or more baskets.

According to the present invention, there is also provided a method for mounting an item to a ceiling comprising the steps of: mounting an item to a hub, the hub having an item support structure for supporting the item, a through aperture and a hub securing mechanism; and, releasably securing the hub to an upper support secured to the ceiling, the upper support having an outwardly depending alignment member which extends through the through aperture of the hub, the hub releasably secured to the alignment member using the hub securing mechanism when the alignment member extends through the through aperture of the hub.

The item support structure may comprise an a wheel support assembly having a means for engaging a wheel and having an outwardly extending hollow shaft, the hollow shaft configured for insertion in a centerbore of the wheel and for guiding the hub along the alignment member. In the method, the releasably securing of the hub to the upper support may comprise securing the hub to a lower portion of the alignment member, releasing the securement of the hub and moving the hub along the alignment member to a higher portion of the alignment member, and repeating the securing, releasing and moving of the hub until the item is supported at a desired position on the alignment member. In the method, the alignment member may be extended by an extender releasably connected to the alignment member and the extender may be removed after the hub is secured to the alignment member in a position above the extender.

### BRIEF DESCRIPTION OF THE DRAWINGS

Having summarized the invention, embodiments thereof will now be described with reference to the accompanying figures, in which:

FIG. 1 shows an iso-metric view of the apparatus as described herein;

FIG. 2 shows an iso-metric view of the upper support;

FIG. 3 shows a side view of the upper support of FIG. 2;

FIG. 4 shows a iso-metric view of the hub;

FIG. 5 shows iso-metric views of the hub, with wheel supported therein, where FIG. 5a is a view from the bottom and FIG. 5b is from the top;

FIG. 6 shows a side view of the hub of FIG. 4;

FIG. 7 shows a front view of the hub of FIG. 4;

FIG. 8 shows an iso-metric view of the hub of FIG. 4, with hollow shaft and handles removed;

FIG. 9 shows a top view of the hub of FIG. 8;

FIG. 10 shows an iso-metric view of the hollow shaft, isolated from other elements of the hub;

FIG. 11 shows an iso-metric view of the extender;

FIG. 12 shows a side view of the extender of FIG. 11;

FIG. 13 shows an enlarged iso-metric view of the connection end of the extender of FIG. 11;

FIG. 14a shows an iso-metric view of the connection of the upper support and extender, forming the spring-loaded bayonet connection;

FIG. 14b shows a cross-sectional view of the apparatus of FIG. 14a, illustrating the spring-loaded bayonet connection;

FIG. 15 shows an iso-metric view of the apparatus of FIG. 1, with extender connected to the alignment member;

FIG. 16 shows a side view of the apparatus of FIG. 15;

FIG. 17 shows a front view of the apparatus of FIG. 15;

FIG. 18 shows an iso-metric view of the apparatus of FIG. 15, illustrating the alternative embodiment basket item support structure; and

FIG. 19 shows a front view of the apparatus of FIG. 18.

FIG. 20 shows an iso-metric view of the apparatus of FIG. 18, with the alternative embodiment item support structure having a basket support bracket.

FIG. 21 shows a side view of the apparatus of FIG. 20.

FIG. 22 shows an iso-metric view of the basket support bracket of FIG. 20, isolated from other elements of the hub.

### DETAILED DESCRIPTION

Throughout the drawings, like features will be designated by like reference numerals. Therefore, features corresponding to reference numerals shown in a drawing may not be described with reference to that particular drawing, but instead described with reference to another drawing. Similarly, features described with reference to a particular drawing may not be indicated with a reference on that drawing, but will be indicated with a reference numeral on another drawing.

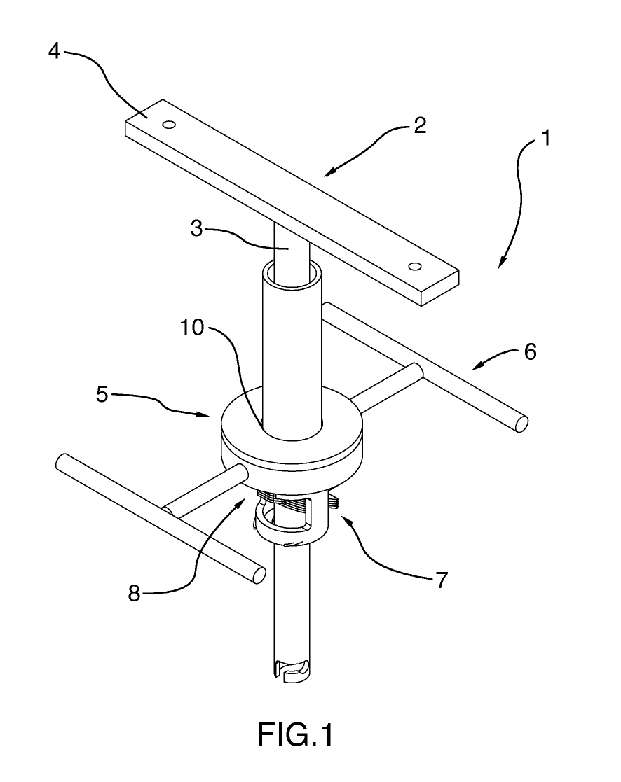

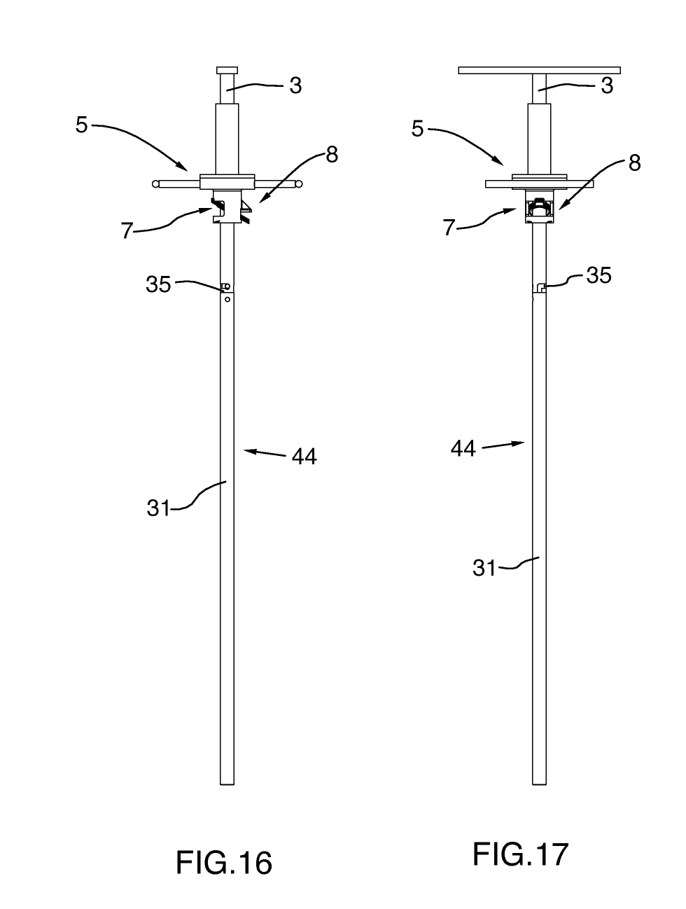

An apparatus for mounting an item to a ceiling according to the present invention is generally illustrated in FIGS. 1 to 19. Referring to FIG. 1, the apparatus 1 comprises an upper support 2 and a hub 5. The upper support 2 further comprises an alignment member 3 outwardly depending from an upper support bracket 4. The hub 5 comprises an item support structure 6 and a through aperture 10 through which the alignment member 3 can extend. The hub 5 further comprises a hub securing mechanism 7 for releasable securing of the hub 5 to the alignment member 3 when the alignment member 3 extends through the through aperture 10 of the hub 5.

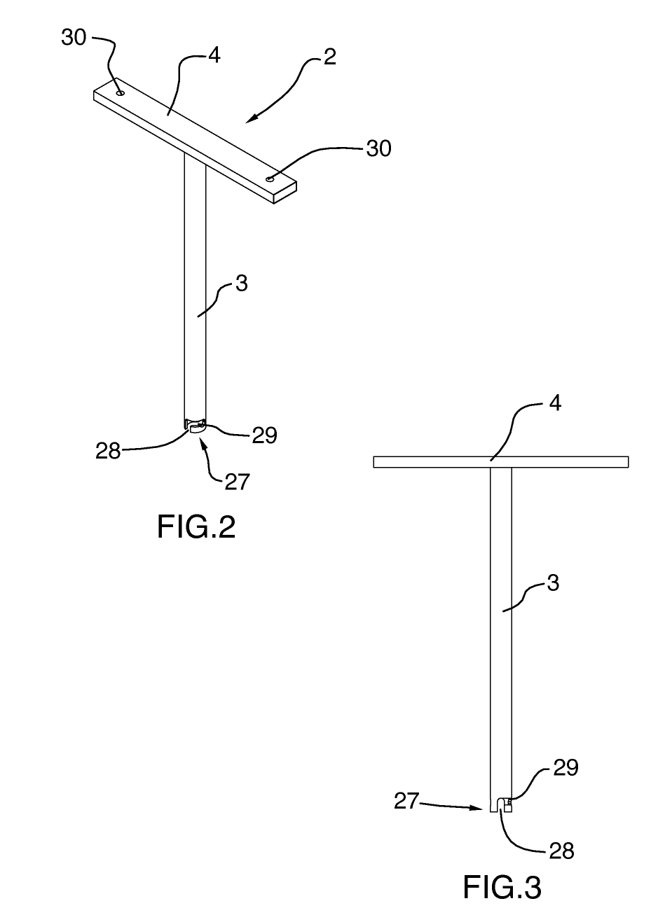

As seen in FIGS. 2 and 3, the upper support 2 comprises an upper support bracket 4 and an outwardly depending alignment member 3. The upper support bracket 3 can be attached to a ceiling surface, using any number of attachment means known in the art, for securing the upper support 2 to the ceiling. As illustrated in the embodiment of FIG. 2, the upper support bracket can contain openings 30 through which screws (or other forms of similar fasteners) can be used to secure the upper support 2 to the ceiling. In the preferred embodiment of FIGS. 2 and 3, the alignment member constitutes a solid cylindrical tube having a connection end 27 forming a bayonet connection.

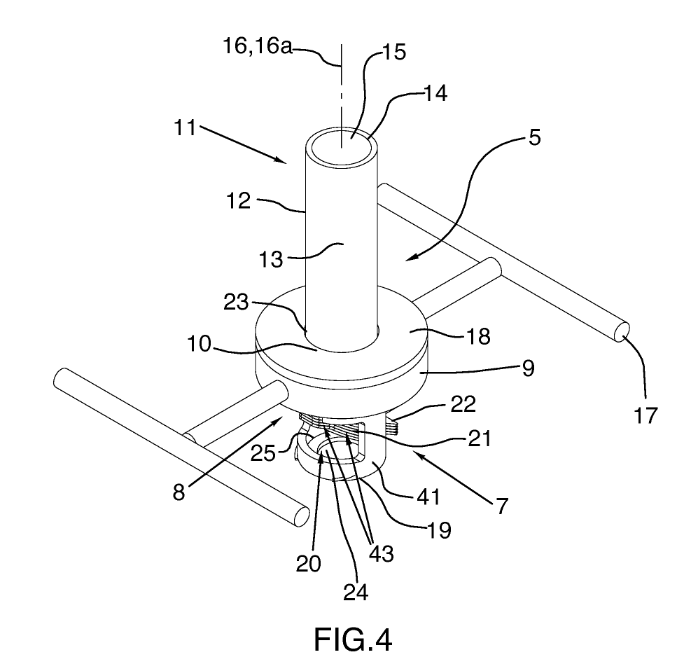

In one embodiment illustrated in FIGS. 1 to 10, the item support structure 6 comprises a wheel support assembly 8. As best illustrated in FIGS. 4 to 9, the wheel support assembly 8 comprises a means for engaging a wheel and an outwardly extending hollow shaft 11 configured for insertion in the centerbore 38 of a wheel 37. Furthermore, the hollow shaft 11 is configured for guiding the hub 5 along the alignment member 3.

Referring specifically to FIGS. 4 to 7, the means for engaging the wheel comprises an annular flange 9 and a pair of handles 17 extending radially outward from the hub 5, for supporting the wheel 37. Optionally, a washer 18 may be inserted upon the hub 5, resting upon the annular flange 9. As illustrated in FIG. 4, the outwardly extending hollow shaft 11 comprises a hollow tube 12, with an outer external wall 13 and an interior wall 14 forming a hollow center cavity 15. The hollow tube 12 is aligned with the through aperture 10 of the hub 5 along the central axis 16 of the hub 5.

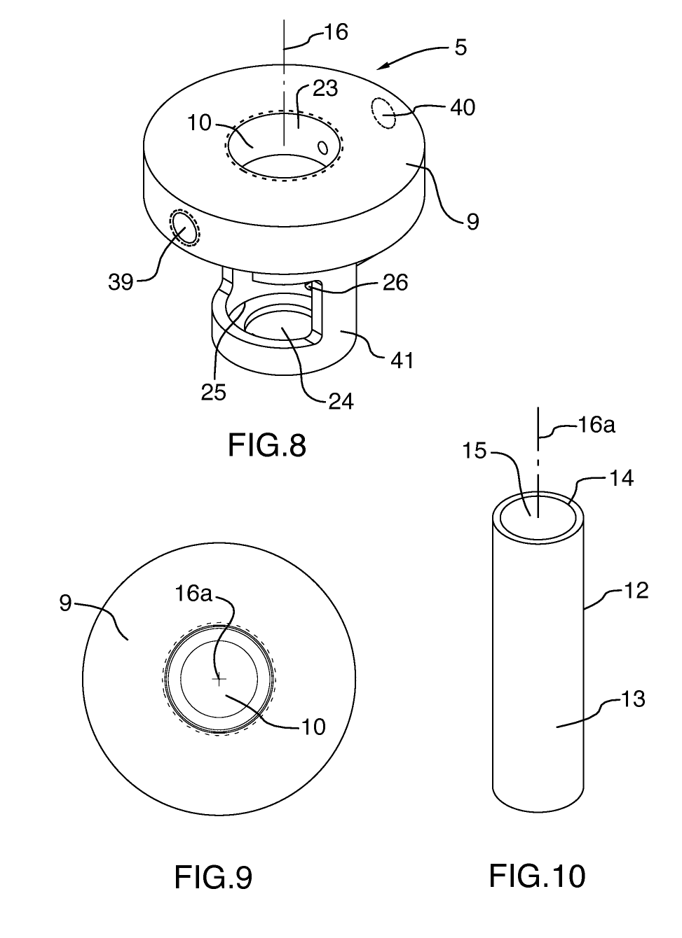

FIGS. 8 to 10 illustrate the hollow tube 12 disassembled from the hub 5. Referring to FIGS. 8 and 9, the hub 5 comprises a one-piece solid construction having an annular flange 9 that extends radially outward from the central axis 16 of the hub 5, and a shaft collar 41 that extends downward from the annular flange 9. Positioned on the annular flange 9 is a pair of first and second handle holes 39, 40 that receive and retain the pair of handles 17. The handles 17 may be frictionally engaged into the handle holes 39, 40, or may be connected using any of means known in the art including a screw fastener or other similar connection means. The through aperture 10 comprises a top opening 23 defined by the annular flange 9 and a bottom opening 24, the combination of the top and bottom openings 23, 24 defining ends of the through aperture 10 which extends through the hub 5. As seen in FIG. 8, the hub further comprises a front opening 25 and rear opening 26, formed as openings on the shaft collar 41, which openings support the function of a spring loaded locking mechanism 20 (described in detail below).

Referring to FIG. 10, the hollow tube 12 has an outer external wall 13 and an interior wall 14 forming a hollow center cavity 15. The hollow tube 12 has a central longitudinal axis 16a. As best illustrated in FIG. 4, the hollow tube 12 is inserted into the top opening 23 and secured within the through aperture 10 by frictional engagement or any other means known in the art. When secured within the through aperture 10 of the hub 5, the central axis 16a of the hollow tube 12 is aligned within central axis 16 of the hub 5, thereby aligning the hollow tube 12 with the through aperture 10 of the hub 5. Furthermore, when the hollow tube 12 is secured within the through aperture 10, the center cavity 15 of the hollow tube 12 is aligned with the through aperture 10, forming a passageway which extends through the hollow tube 12 and the hub 5.

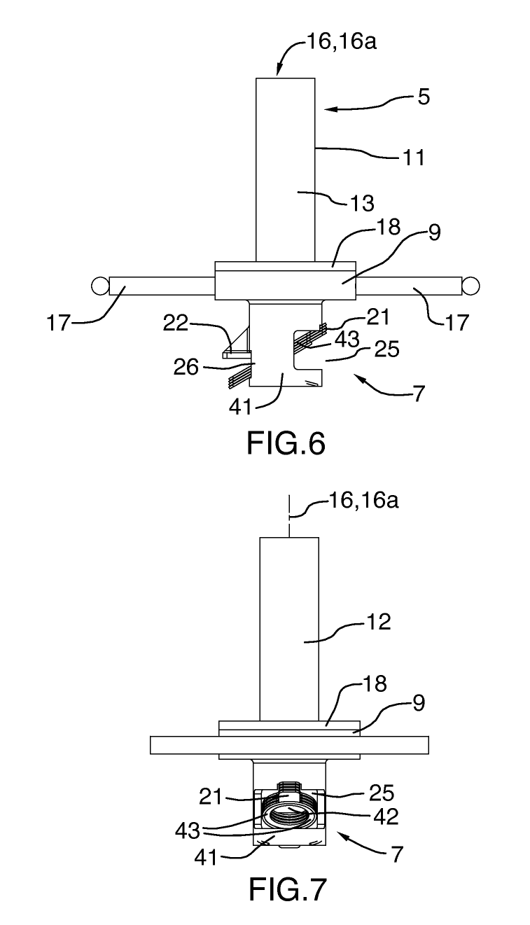

The hub further comprises a hub securing mechanism 7 for releasably securing the hub 5 to the alignment member 3. As seen in the embodiment of FIGS. 4 to 7, the hub securing mechanism 7 comprises a shaft collar 41. While the shaft collar 41 may comprise any locking mechanism commonly used in the art, such as screw clamps or pin locks, the shaft collar 41 of the preferred embodiment further comprises the spring loaded release mechanism 20. The spring loaded release mechanism 20 comprises a U-shaped spring 21, and a front opening 25 and rear opening 26 located on the shaft collar 41. The spring loaded release mechanism 20 further comprises a release element 22. As illustrated in FIGS. 6 and 7, the U-shaped spring 21 extends through the shaft collar 41, extending outward from both the front opening 25 and rear opening 26 of the shaft collar 41. Positioned above the rear opening 26 is the release element 22, which release element 22 is in contact with the U-shaped spring 21. The U-shaped spring 21 further comprises a central open channel 42 defined by a pair of outer arms 43. The through aperture 10 passes through the U-shaped spring 21 via the open channel 42 located within the center of the spring 21.

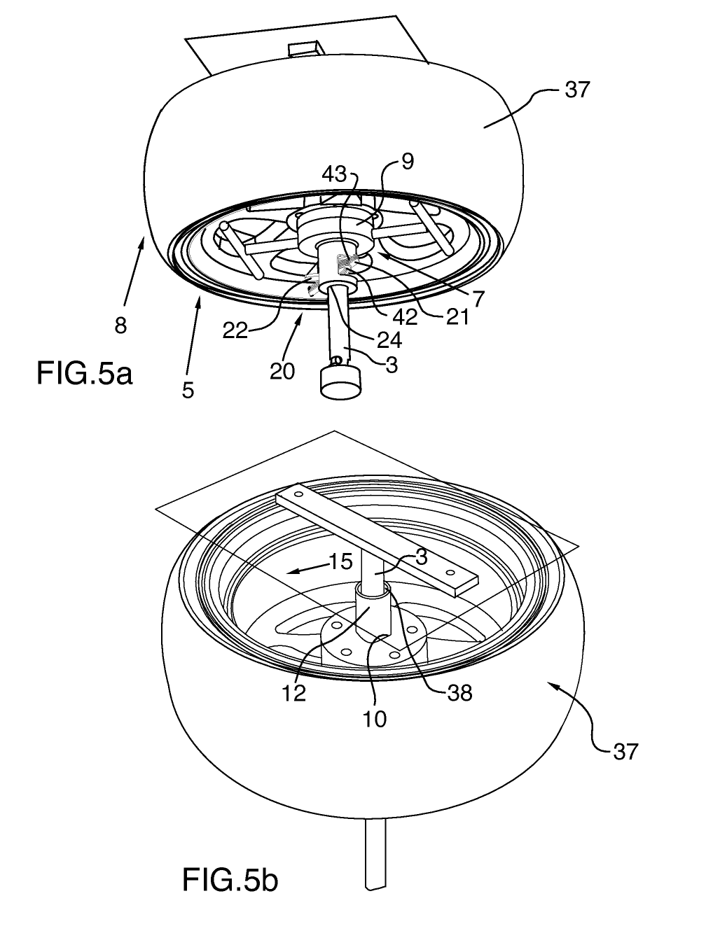

Referring to FIGS. 5a and 5b, when in use, the hollow tube 12 is configured for insertion in the centerbore 38 of a wheel 37 and for receiving the alignment member 3. The alignment member 3 extends through the center cavity 15 of the hollow tube 12 and extends through the through aperture 10 of the hub 5. As such, the alignment member 3 extends through the hollow tube 12, the centerbore 38 of the wheel 37 and the through aperture 10 of the hub 5 when the wheel 37 is supported on the wheel support assembly 8. When using the apparatus 1, the hollow shaft 11 is inserted through the centerbore 38 of the wheel 37, with the annular flange 9 and handles 17 supporting the weight of the wheel 37. The wheel support assembly 8 engages the wheel 37 through insertion of the hollow tube 12 through the centerbore 38 of the wheel 37. The annular flange 9 and handles 17 engage and support the weight of the wheel 37. The hub 5, with wheel support assembly 8 engaging and supporting the wheel 37, is then secured to the alignment member 3. The hollow tube 12 is configured to receive the alignment member 3 within the center cavity 15, and the alignment member 3 extends through the hollow tube 12 and through the through aperture 10 of the hub 5, extending outward from the bottom opening 24 of the through aperture 10. As such, the hollow tube 12 is configured to receive the alignment member 3 and guide the hub 5 along the alignment member 3 when a user is moving the hub 5 and wheel 37 upward along the alignment member 3 to secure the hub 5 and wheel 37 to the upper support 2.

When the alignment member passes through the through aperture 10 of the hub, it extends through the open channel 42 of the U-shaped spring 21. As seen in FIG. 5a, when a downward force is applied to the hub 5, which downward force would come from the weight of the wheel 37 during use of the apparatus 1, the outer arms 43 of the U-shaped spring 21 are biased into contact and frictional engagement contact with the alignment member 3. When frictionally engaged to the alignment member 3, the U-shaped spring 21 secures the hub 5 to the alignment member 3. When a downward force is applied by a user to compress the release element 22, the release element 22 presses down against the U-shaped spring 21, thereby bending the U-shaped spring 21 and releasing it from biased frictional engagement with the alignment member 3. Accordingly, a user may slide the hub 5 and the wheel support assembly 8, along with a wheel 37 engaged and secured within the wheel support assembly 8, vertically upward along the alignment member 3, and the spring loaded release mechanism 20 will automatically secure the wheel 37 and hub 5 in position along the alignment member 3 due to the weight of the wheel 37. A user can easily release the hub 5 and wheel 37 from the alignment member 3 by compressing the release element 22, thereby releasing the hub 5 from secured engagement with the alignment member 3.

Accordingly, a user can mount an item to a ceiling by mounting the item to item support structure 6 of the hub 5. The hub 5 is releasably secured to the upper support 2, by sliding the hub 5 along the alignment member 3, the alignment member extending through the through aperture 10 of the hub 5. When the alignment member 3 extends through the through aperture 10 of the hub 5, the hub 5 is releasably secured to the alignment member 3 using the hub securing mechanism 7.

Using this method, a user can easily mount a wheel to the ceiling of their home, including the ceiling of a garage, for convenient storage. The wheel 37 is mounted to the wheel support assembly 8 of the hub 5, and the hub 5 and wheel 37 are guided along the alignment member 3. The alignment member 3 extends through the hollow tube 12, the centerbore 38 of the wheel 37 and the through aperture 10 of the hub 5 when the wheel 38 is supported on the wheel support assembly 8 and secured to the alignment member 3. The hub 5 is automatically secured to the alignment member 3 by the spring loaded release mechanism 20. When a user wishes to remove the wheel 37, the wheel 37 can be conveniently dismounted from the upper support 2 by compressing the release element 22, thereby releasing the hub 5 from secured engagement with alignment member 3 and allowing the user to slide the hub 5 and wheel 37 vertically downward and off of the alignment member 3.

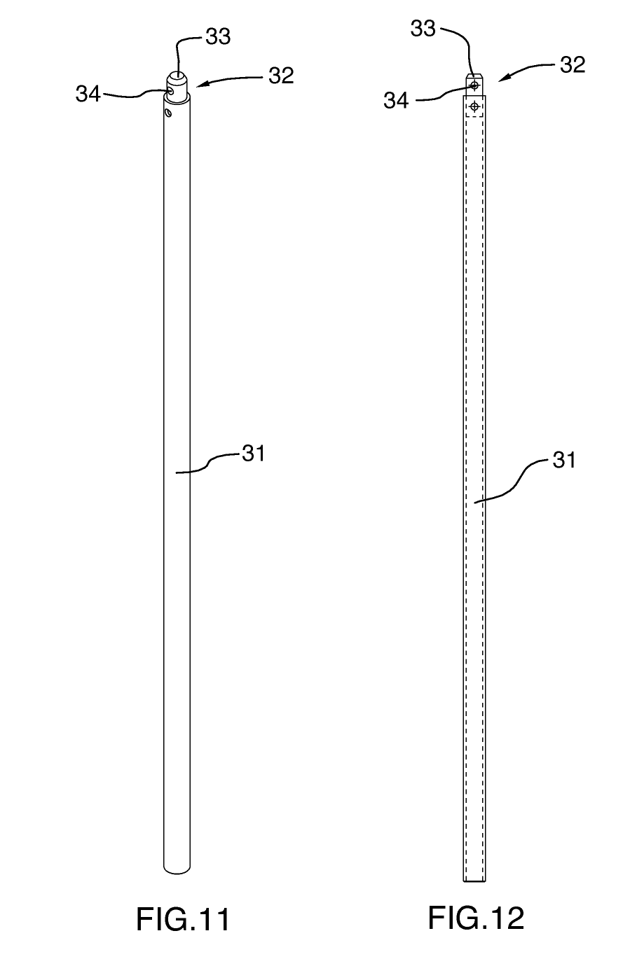

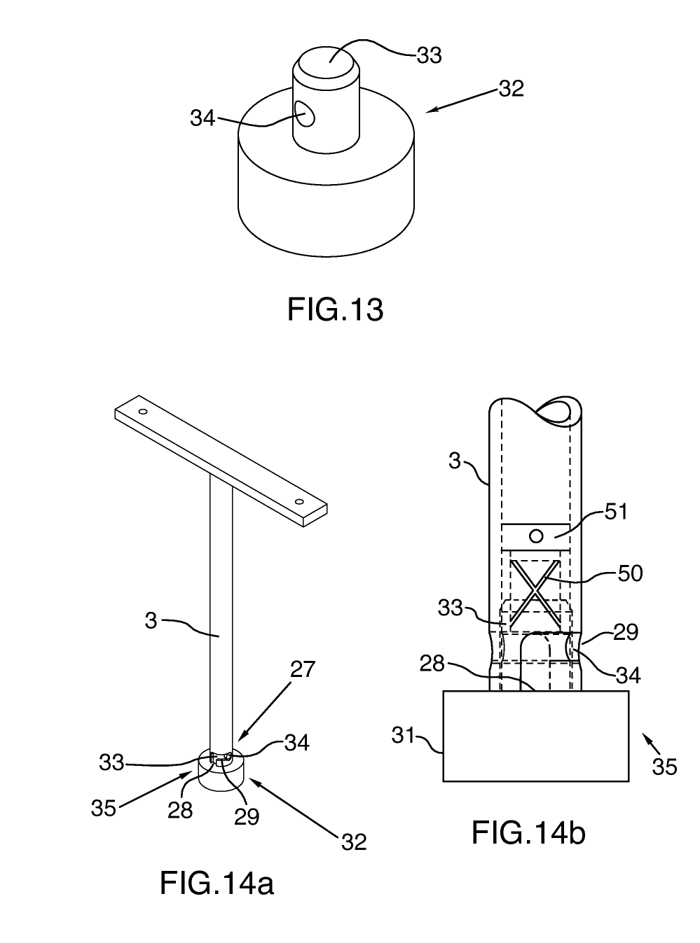

Referring to FIGS. 11 and 12, the apparatus 1 may further comprise an extender 31 that can be releasably secured to the alignment member 3. The extender 31 has a connection end 32 for securing the extender 31 to the alignment member 3. As further illustrated in FIG. 13, the connection end 32 comprises a connection peg 33 having a pin 34 disposed thereupon.

FIGS. 14a and 14b illustrate the operation of releasably connecting the extender 31 to the alignment member 3. As seen in FIG. 14a, the connection end 27 of the alignment member 3 and the connection end 32 of the extender engage to form a spring-loaded bayonet connection 35 for releasable connection of the extender 31 to the alignment member 3. The connection end 27 of the alignment member 3 contains an opening 28 configured for receiving the connection peg 33 of the extender 31. Furthermore, adjacent and connected to the opening 28 at the connection end 27 of the alignment member 3 is a slot 29 for receiving and retaining the pin 34. The connection peg 33 is inserted into the opening 28 and correspondingly the pin 34 is received within the slot 29. FIG. 14b illustrates the operation of the spring-loaded bayonet connection 35. As seen in FIG. 14b, the spring-loaded bayonet connection is comprised of a compression spring 50 and a plug 51. The plug 51 is retained within the alignment member 3 by welding the plug 51 to the interior wall of the alignment member 3. However, other methods of adhesion known in the art may be used to retain the plug 51 within the alignment member 3. Likewise, the compression spring 50 is retained within the alignment member 3 at the connection end 27 by welding the compression spring 50 to the plug 51.

As seen in FIGS. 14a and 14b, the compression spring 50 is compressed between the peg 33 and the plug 51 as the peg 33 is inserted into the opening 28, thereby applying a downward force upon the extender 31. In order to secure the extender 31 to the alignment member 3, the extender 31 is rotated clockwise in order to bring the pin 34 within the slot 29. The compressive force of the spring 50 presses the pin 34 into contact with the slot 29, securing the pin 34 within the slot 29, thereby securing the extender 31 to the alignment member 3. In order to release the extender 31 from the alignment member 3, the extender is rotated counter-clockwise until the pin 34 is no longer retained within the slot 29, and the compressive downward force of the spring 50 ejects the extender 31 outward from the opening 28 of the alignment member 3.

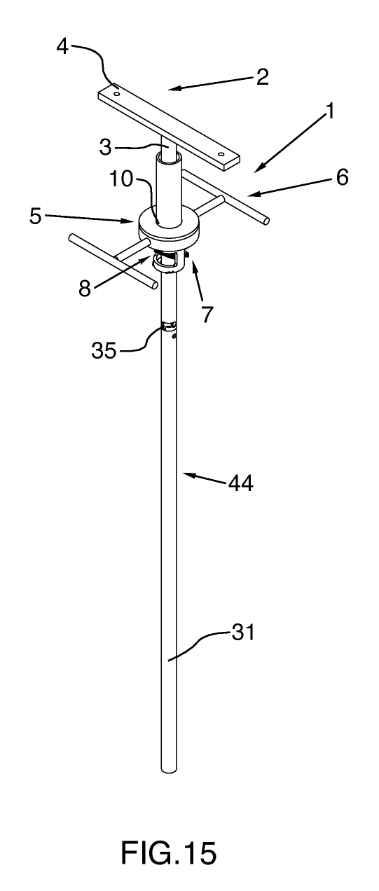

FIGS. 15 to 17 illustrate the extender 31 when connected to the alignment member 3 via the spring-loaded bayonet connection 35. When connected to the alignment member 3, the extender 31 extends the overall length of the alignment member 3 and forming a continuous, extended alignment member 44. When the upper support 2 is connected to a ceiling surface, the upper support 2 may be at a height that is difficult for the average user to conveniently reach. The extended alignment member 44 allows for convenience and ease of use by alleviating the need on the part of a user to reach upward, carrying the heavy weight of wheel support assembly 8 (with a wheel), to secure the wheel support assembly 8 to the alignment member 3. The extended alignment member 44 allows a user to conveniently align the hub 5 with upper support 2 and guide the hub 5 upward to the upper support 2, as the extended alignment member 44 extends down to a height that is commensurate with the height of a user.

The extender 31 is connected to the alignment member 3 via the spring-loaded bayonet connection 35. The extended alignment member 44 is received by, and extends through the through aperture 10 of the hub 5. A user guides the hub 5 vertically along the extended alignment member 44, until the hub 5 (and any item supported therein) reaches the upper support 2. The hub 5 is secured to the alignment member 3 of the upper support 2 using the hub securing mechanism 7. Thereafter, a user may release the extender 31 from the alignment member 3, thereby mounting the item of interest to the ceiling surface.

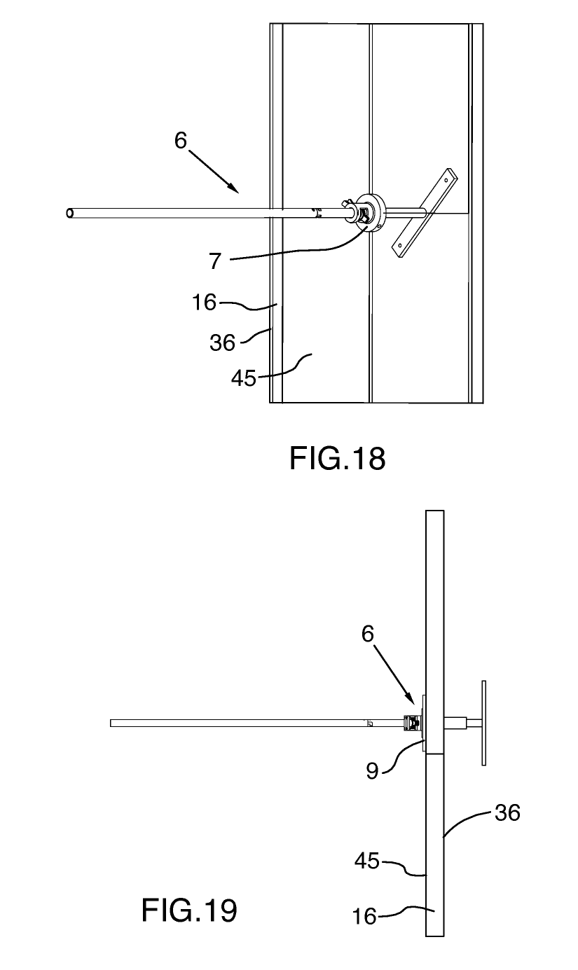

FIGS. 18 to 22 illustrate an alternative embodiment of the apparatus 1, wherein the item support structure 6 comprises a basket 36. Referring to FIGS. 18 and 19, the basket 36 comprises a square structure having a solid base 45, and a solid side wall 46 extending upward from the base 45. The basket 36 may be formed as a single solid piece or fabricated as separate components attached by any means known in the art. In the preferred embodiment, the basket 36 is formed from a flattened piece of expanded metal, with the side wall 46 formed by folding the edges of the piece of expanded metal upwards. Likewise, the basket 36 may be formed as a single-piece, thermoplastic molded component, similar to any plastic baskets well known and used in the art.

As illustrated in FIGS. 18 and 19, the base 45 is mounted to the annular flange 9 through any means known in the art sufficient to support the weight of any items stored in the basket 36 under specific requirements. Although the embodiment of FIGS. 18 and 19 illustrate a basket of square configuration, the shape or size of the basket 36 may be modified by one skilled in the art in order to suit the requirements of specific users or applications. Items are supported upon the base 45, the alignment member 3 is inserted through the through aperture 10 of the hub 5 and a user guides the hub 5 upward along the alignment member 3. The hub 5 is then secured to the alignment member 3 using the securing mechanism 7. Depending on the size and shape of the basket 36, a variety of different items may be mounted using the basket 36.

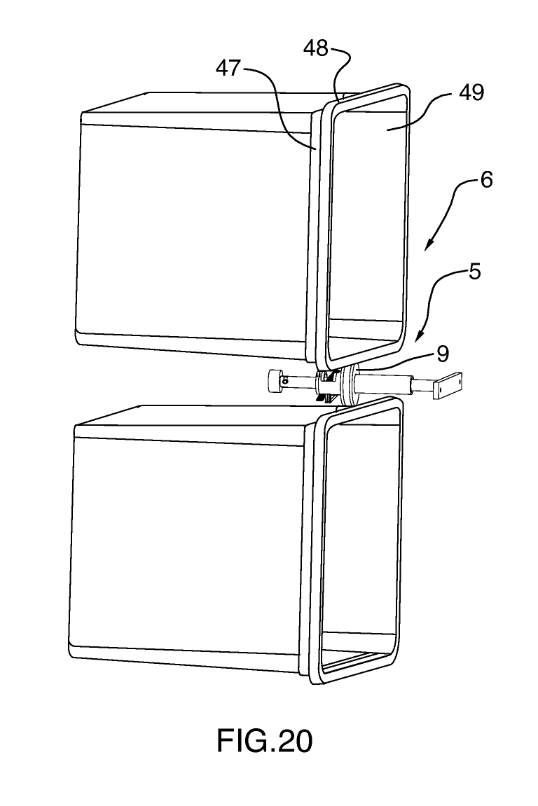

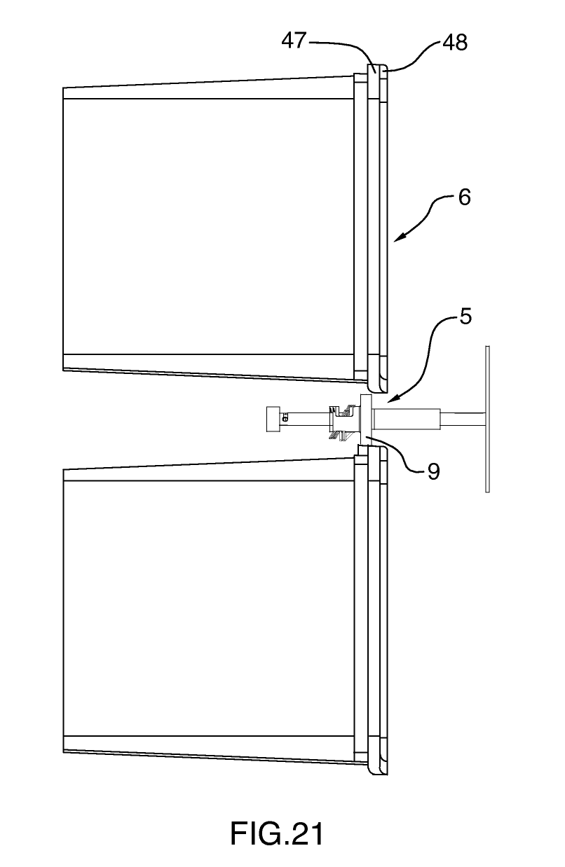

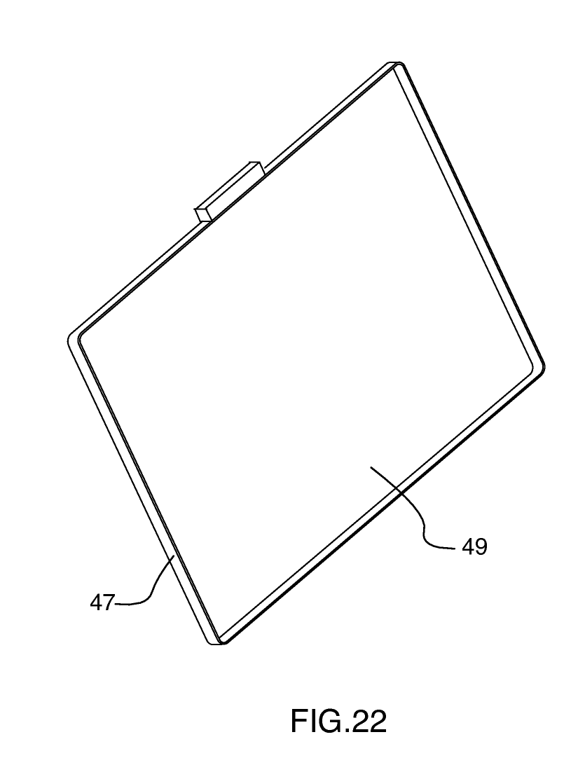

FIGS. 20 to 22 illustrate an alternative embodiment wherein the items support structure 6 further comprises one or more basket support brackets 47, for supporting one or more baskets. Referring to FIGS. 20 and 21, the basket support bracket 47 extends outward from the annular flange 9 of the hub 5, and corresponds with an upper flange 48 of the basket 36. As seen in FIG. 22, the basket support bracket 47 is of rectangular configuration for supporting a rectangular shaped basket 36, but as described above, the basket 36 can be formed of any shape or size and one skilled in the art could modify the shape of the basket support bracket 47 to correspond with the shape of the basket 36. The bracket 47 can be connected to the hub 5 by any means known in the art, and in the embodiment of FIGS. 20 and 21, the metal bracket 47 is welded to the annular flange 9 of the hub 5.

Referring to FIGS. 20 and 21, the basket 36 is inserted through the opening 49 formed by the bracket 47. The upper flange 48 of the basket 36 engages and is supported by the bracket 47. As seen in FIGS. 20 and 21, one or more brackets 47 may be connected to the hub 5, for supporting one or more baskets 36. The embodiment of FIGS. 20 and 21 illustrates two separate brackets supporting two baskets, but depending on the size and shape of the basket 36, and desired use, one skilled in the art could use any number of brackets.

Additional variants, equivalents, embodiments and features of the invention can be conceived by persons of skill in the art and are intended by the inventor to be encompassed by the following claims. The invention is defined only as set out in the claims hereof and such claims are intended to be construed broadly within the meaning supported by the specification.

1. An apparatus for mounting an item to a ceiling, comprising:
an upper support securable to the ceiling having an outwardly depending alignment member; and,
a hub comprising an item support structure and a through aperture through which the alignment member can extend and a hub securing mechanism for releasable securing of the hub to the alignment member when the alignment member extends through the through aperture of the hub.

2. The apparatus according to claim 1, wherein the item support structure comprises a wheel support assembly having a means for engaging a wheel and having an outwardly extending hollow shaft, the hollow shaft configured for insertion in a centerbore of the wheel and for guiding the hub along the alignment member.

3. The apparatus according to claim 2, wherein the shaft comprises a hollow tube aligned with the through aperture of the hub and through which the alignment member extends when the alignment extends through the through aperture of the hub.

4. The mounting apparatus according to claim 3, wherein the alignment member extends through the hollow tube, the centerbore of the wheel and the through aperture of the hub when the wheel is supported on the wheel support assembly.

5. The apparatus according to claim 2, wherein the means for engaging the wheel comprises an annular flange, extending radially outward from the hub.

6. The apparatus according to claim 2, wherein the means for engaging the wheel further comprises a pair of handles, extending radially outward from the hub, for supporting the wheel.

7. The apparatus according to claim 1, wherein the item support structure comprises a basket.

8. The apparatus according to claim 7, wherein the item support structure further comprises one or more basket support brackets, for supporting one or more baskets.

9. The apparatus according to claim 1, further comprising an extender releasably connectable to the alignment member for extending the alignment member.

10. The apparatus according to claim 9, wherein the extender comprises a connection end and the alignment member comprises a connection end, wherein the connection end of the alignment member and the connection end of the extender form a spring-loaded bayonet connection for releaseably securing the extender to the alignment member.

11. The apparatus according to claim 1, wherein the hub securing mechanism comprises a shaft collar.

12. The apparatus according to claim 11, wherein the shaft collar comprises a spring loaded release mechanism having a U-shaped spring and a release element in contact with the U-shaped spring, the U-shaped spring biased into frictional engagement with the alignment member for securing the hub to the alignment member when a downward force is applied to the hub and is released from biased frictional engagement upon compression of the release element.

13. The apparatus according to claim 12, wherein the through aperture of the hub passes through the U-shaped spring.

14. A method for mounting an item to a ceiling comprising:
mounting an item to a hub, the hub having an item support structure for supporting the item, a through aperture and a hub securing mechanism; and
releasably securing the hub to an upper support secured to the ceiling, the upper support having an outwardly depending alignment member which extends through the through aperture of the hub, the hub releasably secured to the alignment member using the hub securing mechanism when the alignment member extends through the through aperture of the hub.

15. The method according to claim 14, wherein the item support structure comprises a wheel support assembly having a means for engaging a wheel and having an outwardly extending hollow shaft, the hollow shaft configured for insertion in a centerbore of the wheel and for guiding the hub along the alignment member.

16. The method according to claim 14, wherein the releasably securing of the hub to the upper support comprises securing the hub to a lower portion of the alignment member, releasing the securement of the hub and moving the hub along the alignment member to a higher portion of the alignment member, and repeating the securing, releasing and moving of the hub until the item is supported at a desired position on the alignment member.

17. The method according to claim 16, wherein the alignment member is extended by an extender releasably connected to the alignment member and the extender is removed after the hub is secured to the alignment member in a position above the extender.
